(19) United States
(12) Patent Application Publication
(10) Pub. No.: US 2016/0292791 A1
(43) Pub. Date: Oct. 6, 2016

(54) METHOD AND A COMPUTER SYSTEM FOR FORECASTING THE VALUE OF A STRUCTURED FINANCIAL PRODUCT

(71) Applicant: Swiss Reinsurance Company, Zuerich (CH)

(72) Inventors: Adrian LUESSI, Zug (CH); Juerg TRUEB, Oberengstringen (CH)

(73) Assignee: Swiss Reinsurance Company, Zuerich (CH)

(21) Appl. No.: 15/184,496

(22) Filed: Jun. 16, 2016

Related U.S. Application Data
(62) Division of application No. 12/092,085, filed on Aug. 6, 2008.

(51) Int. Cl. G06Q 40/08; G06F 17/30

(52) U.S. Cl. CPC G06Q 40/08; G06F 17/3053

(57) ABSTRACT

A method and system for forecasting the value of a structured financial product, which can be a weather-based structured financial product. The method and system calculate a forecast value based on forecasted weather data for a defined time period in a defined geographical area, calculate reference weather data from historical data for the defined time, and the defined geographical area, and calculate a quality indicator, indicative of a forecasting quality associated with the forecasted weather data, based on the forecasted weather data and the reference weather data.

### FIELD OF THE INVENTION

The present invention relates to a method and a computer system for forecasting the value of a structured financial product. Specifically, the present invention relates to a computer implemented method and a computer system for forecasting the value of a weather-based structured financial product.

### BACKGROUND OF THE INVENTION

In the insurance industry, insurance policies are provided for insuring against the occurrence of specific weather conditions. Likewise insurance companies and financial services companies offer financial instruments, particularly financial derivatives, generally referred to as structured financial products, that are based on weather conditions. Weather-based structured financial products are investment vehicles whose values are based on specified weather measures, such as temperature, precipitation, hours of sunshine, heating degree days, cooling degree days or wind speed.

U.S. Pat. No. 6,418,417 describes a method for evaluating weather-based financial instruments. For a financial instrument having a start date and a maturity date, and being defined for a particular geographic region and at least one weather condition, a value of the weather-based financial instrument is determined based on historical weather data and future weather data, forecasted for the period between start date and maturity date.

US 2004/0230619 describes a method of generating a pricing model for weather derivatives. The pricing model is based on historical weather data and current weather data. The model utilizes deviations of the current weather data from the historical weather data or from predicted measures.

### SUMMARY OF THE INVENTION

It is an object of this invention to provide a computer implemented method and a computer system for forecasting the value of a weather-based structured financial product based on forecasted weather data. It is a further object of the present invention to provide a computer implemented method and a computer system for forecasting the value of a weather-based structured financial product on the basis of forecasted weather data, wherein the quality of the forecasted weather data is considered.

According to the present invention, these objects are achieved particularly through the features of the independent claims. In addition, further advantageous embodiments follow from the dependent claims and the description.

According to the present invention, the above-mentioned objects are particularly achieved in that, for forecasting a value of a weather-based structured financial product, a forecast value is calculated based on forecasted weather data for a defined time period and a defined geographical area. Reference weather data is calculated from historical weather data for the defined time period and the defined geographical area. Based on the forecasted weather data and the reference weather data, calculated is a quality indicator, indicative of a forecasting quality associated with the forecasted weather data. Calculating reference weather data from the historical weather data and calculating a forecasting quality indicator from the reference weather data and the forecasted weather data make it possible to provide a quality measure for the forecasted value of the financial product. The quality measure enables both investors and providers of the financial product to make better-informed decisions concerning the value of the financial product.

In a preferred embodiment, a reference value is calculated based on the reference weather data, and the value of the financial product is calculated from the reference value and from the forecast value weighted by the quality indicator. Calculating the value of the financial product from the reference value and from the forecast value, and weighting the forecast value with the quality indicator make it possible to adjust the influence of the forecast value on the calculated value of the financial product. The influence of the forecast value depends on the quality of the forecasted weather data. Preferably, the weight of the forecast value increases with improved accuracy of the forecasted weather data over the reference weather data. Consequently, the calculated value of the financial product has an improved probability of being accurate. In addition the presented innovation helps to create and steer an optimal weather derivative portfolio.

Preferably, a forecasted weather index is determined from the forecasted weather data, and the forecast value is calculated by applying structural parameters of the financial product to the forecasted weather index. Likewise, a reference weather index is determined from the reference weather data, and the reference value is calculated by applying the structural parameters of the financial product to the reference weather index. For example, the forecasted weather data, the reference weather data, and the historical weather data include temperature data. Correspondingly, the forecasted weather index and the reference weather index include at least one of average temperature, cumulative temperature, number of healing degree days, and number of cooling degree days for the defined time period and the defined geographical area.

In an embodiment, calculating the quality indicator includes calculating a ranked probability score for the forecasted weather data, calculating a ranked probability score for the reference weather data, and calculating the quality indicator as a ranked probability skill score from the ranked probability score for the forecasted weather data and the ranked probability score for the reference weather data.

In an embodiment, the forecasted weather data is calculated from multi-year historical weather data and from long-term weather forecast data covering one or more months.

In a further preferred embodiment, calculating the forecasted weather data includes determining for the defined time period a first cumulated distribution function for the historical weather data, calculating cumulative values included in terciles of the first cumulated distribution function, and determining for the defined time period a second cumulated distribution function for the forecasted weather data. The second cumulated distribution function is obtained by downscaling the first cumulated distribution function using quantile levels, obtained from the long term weather forecast data, for the cumulative values included in the terciles of the first cumulated distribution function.

In an alternative embodiment, calculating the forecasted weather data includes determining for the defined time period a reference climatology comprising deterministic components from the historical weather data, and calculating the forecasted weather data from the reference climatology and from ensemble forecasts for the defined time period.

In an embodiment, multiple sets of forecasted weather data for subsequent time periods are stored assigned to their respective time period. The forecasted weather data is calculated from the multiple sets of forecasted weather data, each set of forecasted weather data being weighted by a weighting factor having a value increasing from one time period to a subsequent time period. Including weighted sets of forecasted weather data from previous time periods makes it possible to improve the quality (i.e. accuracy) of the forecasted weather data.

In an embodiment, the forecasted weather data includes a first cumulative distribution function of temperature data determined from multi-year historical temperature data and from long term temperature forecast data, covering one or more months. Calculating the reference weather data includes determining a second cumulative distribution function of temperature data by applying a stochastic time series model to the historical temperature data. The forecast value is calculated by applying structural parameters of the financial product to a forecasted weather index determined from the first cumulative distribution function. The reference value is calculated by applying structural parameters of the financial product to a reference weather index determined from the second cumulative distribution function. Calculating the quality indicator includes calculating a first ranked probability score based on the first cumulative distribution function, calculating a second ranked probability score based on the second cumulative distribution function, and calculating the quality indicator as a ranked probability skill score from the first ranked probability score and the second ranked probability score.

In addition to a computer implemented method and a computer system for forecasting the value of a weather-based structured financial product, the present invention also relates to a computer program product including computer program code means for controlling one or more processors of a computer, such that the computer executes the method of forecasting the value of a weather-based structured financial product. Particularly, the computer program product includes a computer readable medium containing therein the computer program code means.

### BRIEF DESCRIPTION OF THE DRAWINGS

The present invention will be explained in more detail, by way of example, with reference to the drawings in which:

FIG. 1 shows a block diagram illustrating schematically an exemplary configuration of a computer system for practicing embodiments of the present invention, said configuration comprising a computer with a display and data entry means.

FIG. 2 shows a flow diagram illustrating an example of a sequence of steps executed according to the present invention for forecasting a value of a weather-based structured financial product.

FIG. 3 shows a block diagram illustrating schematically a stochastic time series model for generating reference weather data based on historical weather data.

FIG. 4 shows a block diagram illustrating schematically a daily anomaly method for generating forecasted weather data, based on historical weather data and long-term weather forecast data.

FIG. 5a shows a cumulative distribution function for historical weather data, cumulative values being indicated for terciles of the distribution function.

FIG. 5b shows a cumulative distribution function of forecasted weather data downscaled based on the cumulative distribution function shown in FIG. 5a.

FIG. 6a shows a cumulative distribution function illustrating the calculation of a ranked probability score for forecasted weather data, determined according to the daily anomaly method.

FIG. 6b shows a cumulative distribution function illustrating the calculation of a ranked probability score for forecasted weather data, determined according to the tercile method.

### DETAILED DESCRIPTION OF THE PREFERRED EMBODIMENTS

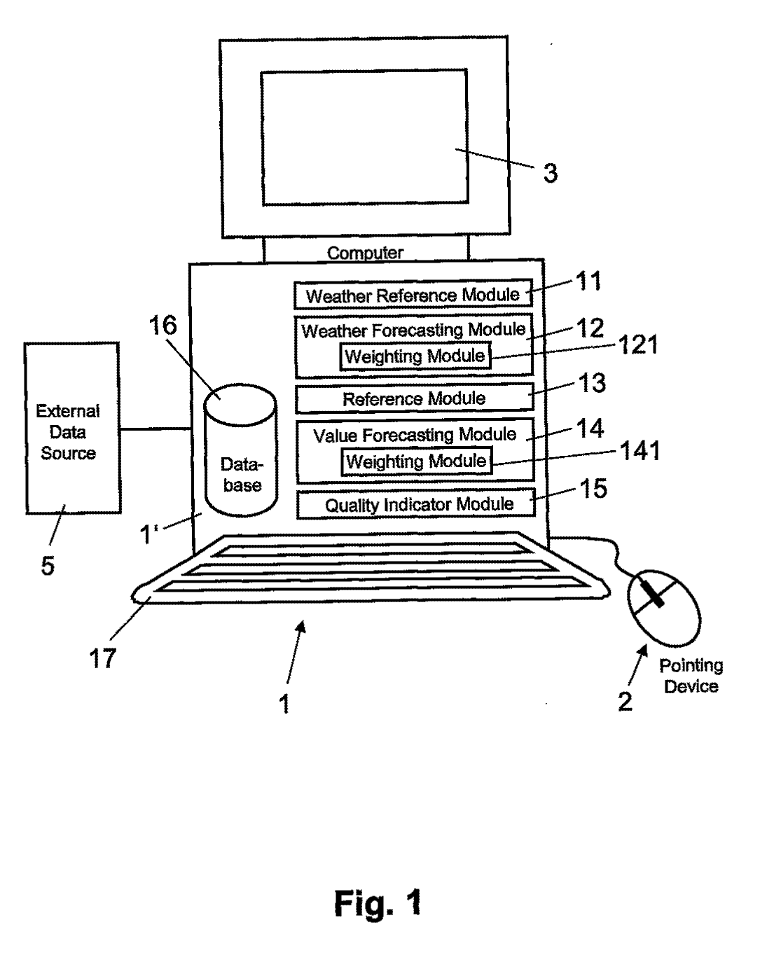

in FIG. 1, reference numeral 1 refers to a computer system. The computer system 1 includes one or more computers 1′, for example personal computers, comprising one or more processors. As is illustrated schematically, the computer system 1 includes a display and data entry means, for example a keyboard 17 and a pointing device 2 in the form of a computer mouse. The computer system 1 further includes memory, a database 16, and various functional modules, namely a weather reference module 11, a weather forecast module 12 with a weighting module 121, a reference module 13, a value forecasting module 14 with a weighting module 141, and a quality indicator module 15. Preferably, the functional modules and the database 16 are implemented as programmed software modules. The computer program code of the software modules is implemented as a computer program product, preferably stored on a computer readable medium, either in memory integrated in a computer 1′ of the computer system 1 or on a data carrier that can be inserted into a computer 1′ of the computer system 1. In a variant, the computer system 1 is connected to an external data source 5, for example via a telecommunications network.

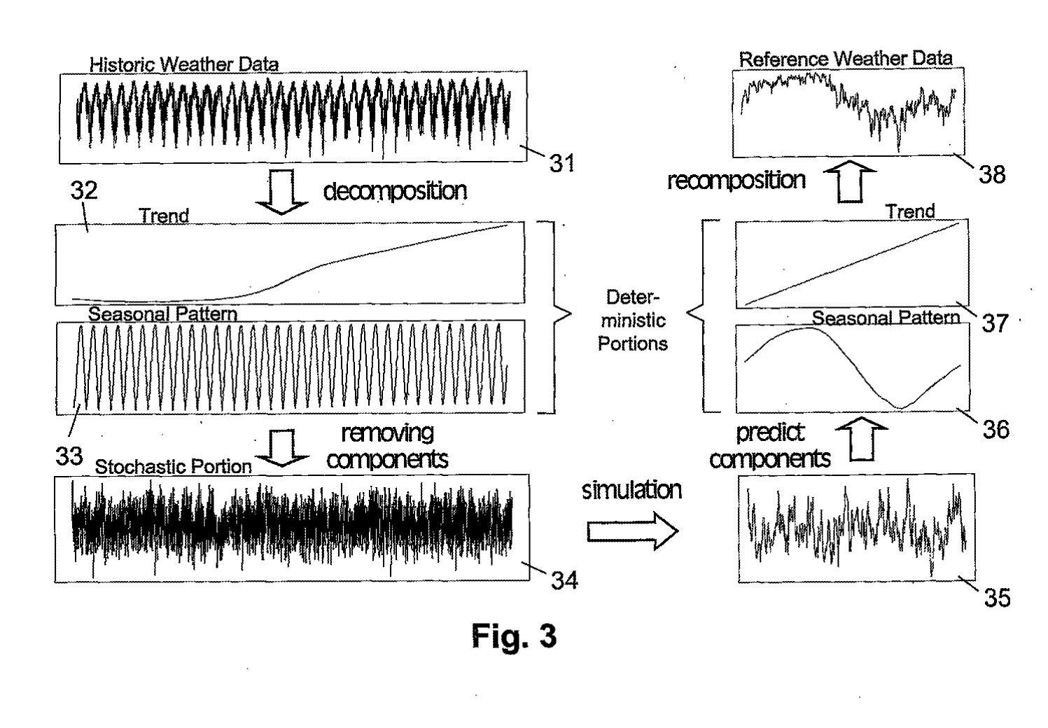

The weather reference module 11 is configured to establish reference weather data, based on the historical weather data. The historical weather data is stored in database 16 or retrieved from external data source 5. As is illustrated in FIG. 3, the historical weather data, illustrated in block 31 as a time series covering many years, is decomposed in portions with deterministic data, illustrated in blocks 32 and 33, and a portion with stochastic data, illustrated in block 34. The deterministic portions include historical trend data, illustrated in block 32, as well as seasonal pattern data, illustrated in block 33. The reference weather data is determined for a defined time period and a defined geographical area. The time period and the geographical area are defined in correspondence with the parameters of the structured financial product to be forecasted. The reference weather data, illustrated in block 38, is simulated through application of a stochastic time series model to the historical weather data. Specifically, the reference weather data is established from the deterministic data, applicable to the defined time period, through auto regression, and from stochastic data determined for the time period. No forecasted weather data is used in determining the reference weather data.

The weather forecast module 12 is configured to establish forecasted weather data, based on multi-year historical weather data and long-term weather forecast data covering one or more months. The historical weather data and the long-term weather forecast data are provided, for example, by a forecasting service provider such as the European Center for Medium range Weather Forecasting (ECMWF) for the defined time period and geographical area. The long-term weather forecast data is stored in database 16 or retrieved from external data source 5.

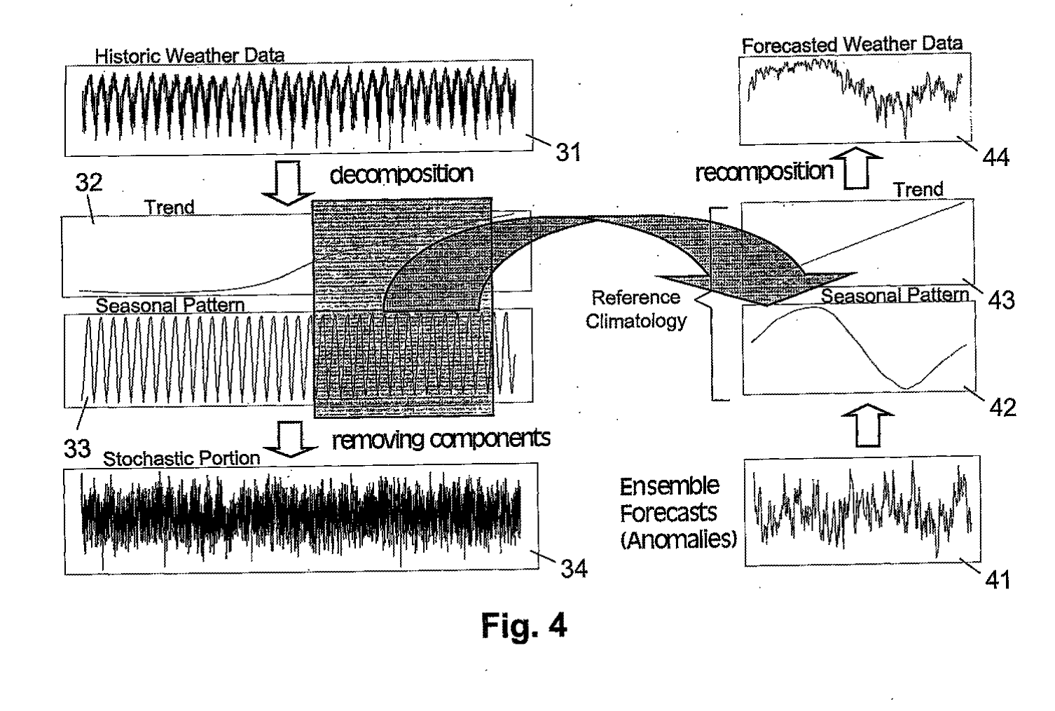

In a first variant, the forecasted weather data is determined using a daily anomaly method illustrated in FIG. 4. In the daily anomaly method, the long-term weather forecast data is provided in the form of so called ensemble forecasts (anomalies), illustrated in block 41. The ensemble forecasts are combined with reference climatology data, illustrated in blocks 42 and 43. The reference climatology data represents a specified number of years of historical data and Includes historical trend data, illustrated in block 43, and seasonal pattern data, illustrated in block 42, for example. The forecasted weather data, illustrated in block 44, is thus generated through recomposition of deterministic weather data and a number (ensemble) of possible forecasts for the defined time period.

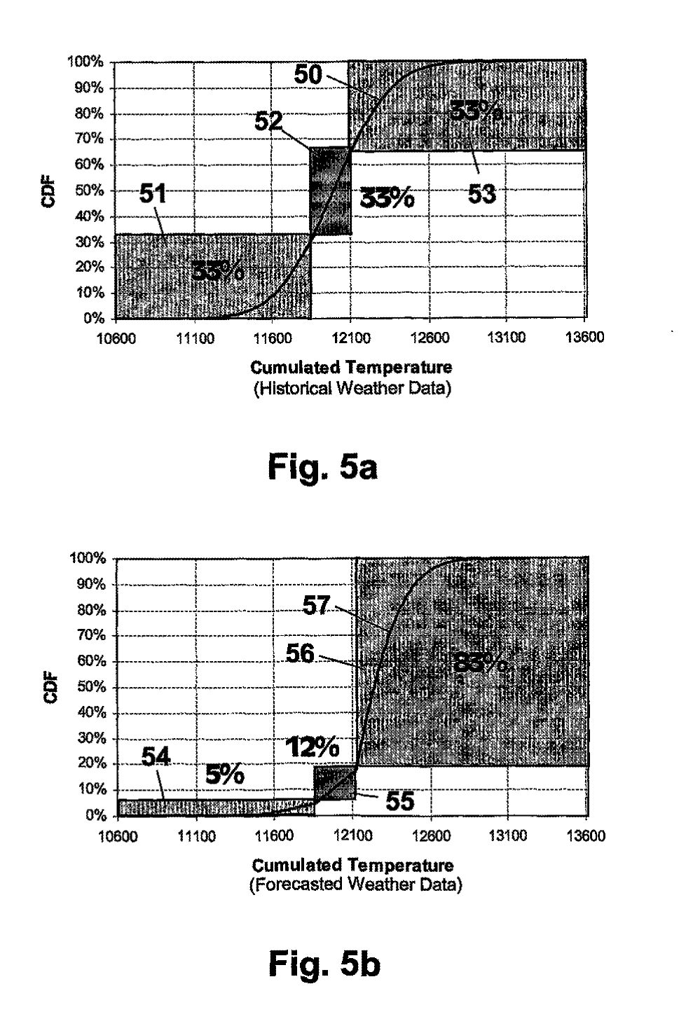

In a second, preferred variant, the forecasted weather data is determined using a tercile method illustrated in FIGS. 5a and 5b. As is illustrated in FIG. 5a, for the historical weather data, a cumulative distribution function 50 is determined for the defined time period, for example, the cumulative distribution of the (daily) temperature in the defined time period. For each tercile 51, 52, 53 (quantile of one third) of the historical weather data's cumulative distribution function 50, calculated are the cumulative values (e.g. 11850, 12100 and 13600) included in the tercile 51, 52, 53. As is illustrated in FIG. 5b, for the forecasted weather data, a cumulative distribution function 57 is determined for the defined time period. From the long-term weather forecast data, determined are quantile levels (e.g. 5%, 12% and 83%) corresponding to the cumulative values (e.g. 11850, 12100 and 13600) included in the terciles 51, 52, 53 of the cumulative distribution function 50 of the historical weather data. The cumulated distribution function 57 for the forecasted weather data is established by downscaling the cumulated distribution function 50 of the historical weather data, using the quantile levels (e.g. 5%, 12% and 83%) determined from the long term weather forecast data.

Multiple sets of forecasted weather data for subsequent time periods are stored in database 16 assigned to their respective time period. The weighting module 121 is configured to calculate forecasted weather data, to be used for further computation, from the multiple sets of forecasted weather data stored in database 16. Each set of forecasted weather data is weighted by a weighting factor having a value that increases from one time period to the next subsequent time period. For example, the length of a time period is one month and the sets of forecasted weather data includes forecasted weather data for the current month and for time periods having a lag of one, two, three and four months. For example, the forecasted weather data, to be used for further computation, is calculated using weighting factors of 60%, 20%, 10%, 7.5% and 2.5% for the current month or for the time periods having a lag of one, two, three and four months, respectively.

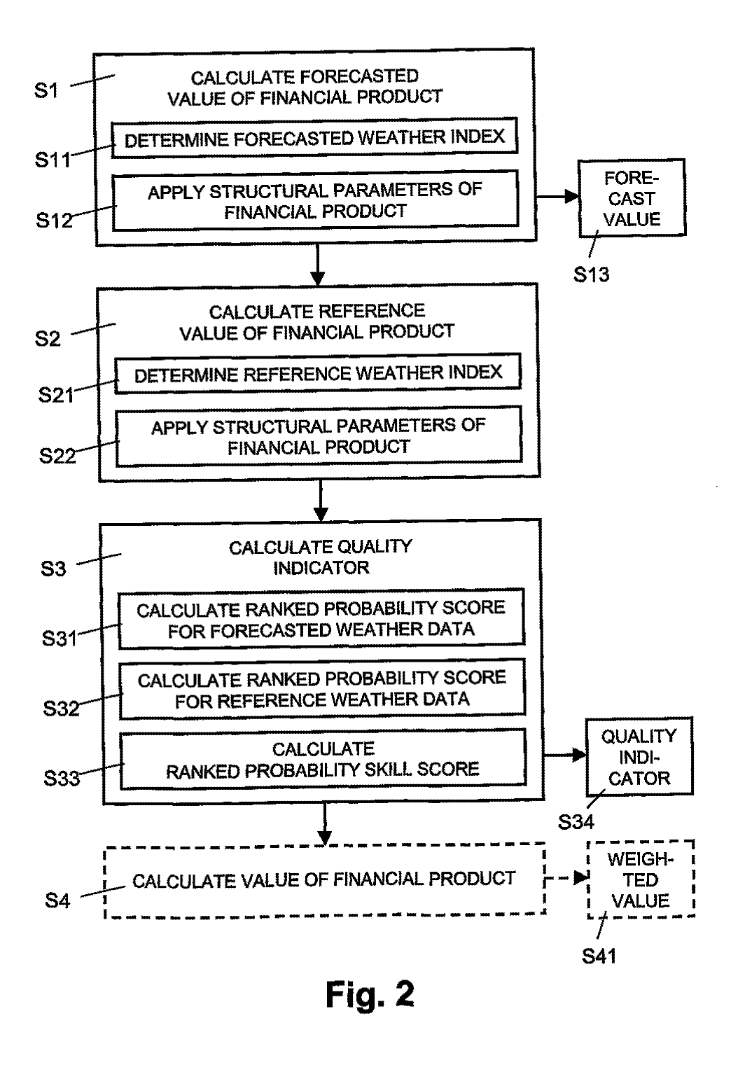

In the following paragraphs, an example of a sequence of steps executed according to the present invention for forecasting a value of a weather-based structured financial product is described with reference to FIG. 2.

In step S1, the value forecasting module 14 calculates a forecasted value of a structured financial product. At first, a forecasted weather index is calculated from the forecasted weather data calculated according to the daily anomaly method or tercile method, described above with reference to FIG. 4 or 5a and 5b, respectively. For example, the historical weather data and consequently the forecasted weather data include temperature data, and the forecasted weather index includes the average temperature, the cumulative temperature, the number of heating degree days, or the number of cooling degree days for the defined time period and the defined geographical area. The type of index is defined by a respective parameter of the financial product to be forecasted. The forecasted weather index can be calculated from the weather data by the anomaly method illustrated in FIG. 4. Alternatively, the tercile method shown in FIGS. 5a and 5b can be applied to calculate an average or cumulative temperature index. It is possible to extend the tercile method to further indices like cooling or heating degree days. This can be achieved by calculating the conditional distribution of the desired temperature index given the forecasted terciles of the average temperatures. One skilled in the art will understand that the proposed method and system are not limited to temperature data but that weather data can also be represented by precipitation quantities, or speeds and directions of wind, for example. Subsequently, in step S12, the forecasted value of the structured financial product is calculated by applying structural parameters of the financial product to the forecasted weather index calculated in step S11. For example, for financial products having a put or call deal structure, in addition to the geographical area, the type of weather-based index, and the time period, the structural parameters include parameter values for strike (Pₛₜᵣᵢₖₑ), tick (P_{tick}) and limit (Pₗᵢₘᵢₜ). For a put or call deal structure, the forecasted value of the structured financial product is calculated according to formula (1) or (2), respectively.

V_{forcasted-put}=E[min(max((Pₛₜᵣᵢₖₑ−I_{forecasted})·P_{tick},0),Pₗᵢₘᵢₜ)] (1)

V_{forecasted-call}=E[min(max((I_{forecasted}−Pₛₜᵣᵢₖₑ)−Pₛₜᵣᵢₖₑ)·P_{tick},0),Pₗᵢₘᵢₜ)] (2)

I_{forecasted} represents a random variable which follows the forecasted index distribution.

In step S13, the forecasted value of the structured financial product is displayed as output on display 3.

In step S2, the reference module 13 calculates a reference value of the structured financial product. At first, a reference weather index is calculated in step S21 from the reference weather data, calculated as described above with reference to FIG. 3. Corresponding to the historical weather data, the reference weather data includes temperature data, and the reference weather index includes the average temperature, the cumulative temperature, the number of heating degree days, or the number of cooling degree days for the defined time period and the defined geographical area. The reference weather Index is calculated from the reference weather data, as described above for the forecasted weather index. Subsequently, in step S22, the reference value of the structured financial product is calculated by applying the structural parameters of the financial product to the reference weather index calculated in step S21, as explained above for the forecasted value of the financial product.

In step S3, the quality indicator module 15 calculates a quality indicator that indicates the quality of forecasting the forecasted weather data. The quality indicator is calculated based on the forecasted weather data and the reference weather data. In step S31, a ranked probability scare (RPS_{forecasted}) is calculated for the forecasted weather data according to formula (3), wherein CDF_{forecasted} is the cumulative distribution function of the forecasted weather data and CDF_{actual} is the cumulative distribution function of the actual realization, i.e. of weather data describing a relevant weather situation that actually occurred.

RPS_{forecasted}=∫(CDF_{forecasted}(x)−CDF_{actual}(x))²dx (3)

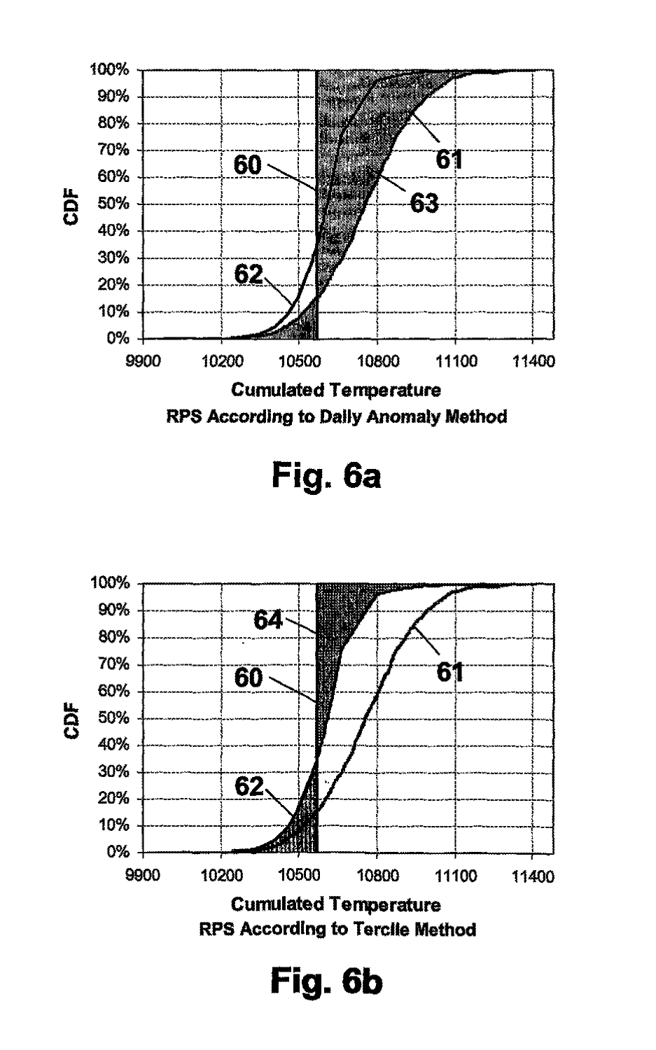

In FIGS. 6a and 6b, the reference numeral 60 denotes the actual realization, the reference numeral 61 denotes the cumulative distribution function CDF_{reference} of the reference weather data, and the reference numeral 62 denotes the cumulative distribution function CDF_{forecasted} of the forecasted weather data derived according to the tercile method. In FIG. 6a, the reference numeral 63 denotes an area representing the ranked probability score for the reference weather data. In FIG. 6b, the reference numeral 64 denotes an area representing the ranked probability score for the forecasted weather data derived according to the tercile method. Clearly, the tercile method produces results closer to the actual realization.

In step S32, a ranked probability score (RPS_{reference}) is calculated for the reference weather data according to formula (4), wherein CDF_{reference} is the cumulative distribution function of the reference weather data.

RPS_{reference}=∫(CDF_{reference}(x)−CDF_{actual}(x))²dx (4)

In step S33, the quality indicator is calculated as a ranked probability skill score (RPSS) calculated from the average ranked probability score for the forecasted weather data and the average ranked probability score for the reference weather data for several years according to formula (5).

R̅P̅S̅S̅=1−R̅P̅S̅_̅{̅f̅o̅r̅c̅a̅s̅t̅e̅d̅}̅/R̅P̅S̅_̅{̅r̅e̅f̅e̅r̅e̅n̅c̅e̅}̅ (5)

The ranked probability skill score indicates the accuracy of the forecast of the weather data compared to the reference weather data. The ranked probability skill score indicates the percentage of improvement in accuracy of the forecast over the reference simulation. The skill score has a value of 0% for a forecast with accuracy equal to that of the reference, derived solely through statistical simulation. Positive scores indicate that the forecast accuracy is an improvement over that of the reference. Negative scores indicate that the forecast accuracy is worse than that of the reference. Note that the calculation of the calculation of the quality indicator is not restricted to the ranked probability skill score only. Alternative quality measures would work with the presented methodology as well.

In step S34, the quality indicator is displayed as output on display 3.

In a preferred option, in step S4, the value forecasting module 14 calculates the forecasted value of the structured financial product from the reference value, calculated in step S2, and from the forecasted value, calculated in step S1. The forecasted value of the structured financial product is calculated from the reference value and the forecasted value using the quality indicator, calculated in step S3, as a weighting factor. The forecasted value V_{forecasted} of the structured financial product is calculated according to formula (6), for example, wherein α(s) is a function of the quality indicator, V_{forecast} is the forecasted valued calculated in step S1, and V_{reference} is the reference value calculated in step S2.

V_{forecasted}=α(s)·V_{forecast}+(1−α(s))·V_{reference} (6)

In step S41, the (weighted) forecasted value V_{forecasted} of the structured financial product is displayed as output on display 3.

It must be pointed out that different sequences of steps are possible without deviating from the scope of the invention. For example, step S32 may be performed prior to step S31.

1. (canceled)

2. A method for forecasting a value of a weather-based structured financial product for steering of an optimal weather derivative portfolio, comprising:
calculating reference weather data from historical weather data stored in a database by means of a weather reference module for a defined time period and a defined geographical area wherein the historical weather data covering a plurality of years as a time series, is decomposed in portions with deterministic data and a portion with stochastic data, wherein the deterministic portions include historical trend data and seasonal pattern data, and wherein the reference weather data is determined for the defined time period and the defined geographical area defined in correspondence with the parameters of the structured financial product to be forecasted by establishing the reference weather data from the deterministic data, applicable to the defined time period, through auto regression, and from stochastic data determined for the time period;
establishing forecasted weather data by means of a weather forecast module based on multi-year historical weather data and long-term weather forecast data covering one or more months and storing the forecasted weather data as multiple sets of forecasted weather data for subsequent time periods in database assigned to their respective time period;
calculating weighted forecasted weather data by means of a weighting module from the multiple sets of forecasted weather data stored in the database, wherein each set of forecasted weather data is weighted by a weighting factor having a value that increases from one-time period to the next subsequent time period;
calculating a forecasted weather index from the forecasted weather data, wherein the type of index is defined by a respective parameter of the financial product to be forecasted, and calculating a forecast value of the structured financial product based on forecasted weather data for a defined time period and a defined geographical area, wherein the forecast value is calculated by applying structural parameters of the financial product to the forecasted weather index determined from the forecasted weather data;
calculating a reference weather index from the reference weather data by means of a reference module, wherein the type of index is defined by a respective parameter of the financial product to be forecasted, and calculating a reference value of the structured financial product based on the reference weather data, wherein the reference value is calculated by applying the structural parameters of the financial product to the reference weather index determined from the reference weather data;
calculating a ranked probability score for the reference weather data by integrating a cumulative distribution function of the forecasted weather data representing the actual relevant weather situation, and calculating a ranked probability score for the forecasted weather data, by integrating a cumulative distribution function of the forecasted weather data representing the actual relevant weather situation;
calculating a quality indicator by means of a quality indicator module, indicative of a forecasting quality associated with the forecasted weather data, based on the forecasted weather data and the reference weather data, wherein the quality indicator is calculated as a ranked probability skill score from the ranked probability score for the forecasted weather data and the ranked probability score for the reference weather data, the ranked probability skill score indicating the accuracy of the forecast of the weather data compared to the reference weather data according to the percentage of improvement in accuracy of the forecast weather data over the reference weather data; and
calculating the value of the financial product by means of a value forecasting module from the reference value and from the forecast value weighted by the quality indicator, wherein the influence of the forecasted value on the calculated value of the financial product is adjusted and wherein the predicted value is a put option value, V_{forecasted-put}, that is specified by:
V_{forecasted-put}=[min(max((Pₛₜᵣᵢₖₑ−I_{forecasted})·P_{tick},0),Pₗᵢₘᵢₜ)], in which
Pₛₜᵣᵢₖₑ is a strike price value of the weather-based structured financial product,
P_{tick} is a tick price value of the weather-based structured financial product,
Pₗᵢₘᵢₜ is a limit price value of the weather-based structured financial product, and
I_{forecasted} represents a random variable which follows a distribution of a forecasted weather index.

3. The method according to claim 2, wherein the forecasted weather data, the reference weather data, and the historical weather data include temperature data; and wherein the forecasted weather index and the reference weather index include one of average temperature, cumulative temperature, number of heating degree days, and number of cooling degree days for the defined time period and the defined geographical area.

4. The method according to claim 2, wherein calculating the quality indicator includes calculating a ranked probability score for the forecasted weather data, calculating a ranked probability score for the probability weather data, and calculating the quality indicator as a ranked probability skill score from the ranked probability score for the forecasted weather data and the ranked probability score for the reference weather data.

5. The method according to claim 2, wherein the forecasted weather data is calculated from multi-year historical weather data and from long-term weather forecast data covering one or more months.

6. The method according to claim 5, wherein calculating the forecasted weather data includes determining for the defined time period a first cumulated distribution function for the historical weather data, calculating cumulative values included in terciles of the first cumulated distribution function, and determining for the defined time period a second cumulated distribution function for the forecasted weather data by downscaling the first cumulated distribution function using quantile levels obtained from the long term weather forecast data for the cumulative values included in the terciles of the first cumulated distribution function.

7. The method according to claim 5, wherein calculating the forecasted weather data includes determining for the defined time period a reference climatology comprising deterministic components from the historical weather data, and calculating the forecasted weather data from the reference climatology and from ensemble forecasts for the defined time period.

8. The method according to claim 2, wherein multiple sets of forecasted weather data for subsequent time periods are stored assigned to their respective time period; and wherein the forecasted weather data is calculated from the multiple sets of forecasted weather data, each set of forecasted weather data being weighted by a weighting factor having a value increasing from one-time period to a subsequent time period.

9. The method according to claim 2, wherein the forecasted weather data includes a first cumulative distribution function of temperature data determined from multi-year historical temperature data and from long term temperature forecast data covering one or more months; wherein calculating the reference weather data includes determining a second cumulative distribution function of temperature data by applying a stochastic time series model to the historical temperature data; wherein the forecast value is calculated by applying structural parameters of the financial product to a forecasted weather index determined from the first cumulative distribution function; wherein the reference value is calculated by applying structural parameters of the financial product to a reference weather index determined from the second cumulative distribution function; wherein calculating the quality indicator includes calculating a first ranked probability score based on the first cumulative distribution function, calculating a second ranked probability score based on the second cumulative distribution function, and calculating the quality indicator as a ranked probability skill score from the first ranked probability score and the second ranked probability score; and wherein the value of the financial product is calculated from the reference value and from the forecast value weighted by the quality indicator.

10. A system for forecasting a value of a weather-based structured financial product for optimized steering of a weather derivative portfolio, comprising:
a weather forecast module for establishing forecasted weather data by means of based on multi-year historical weather data and long-term weather forecast data covering one or more months and to store the forecasted weather data as multiple sets of forecasted weather data for subsequent time periods in database assigned to their respective time period;
a weather reference module for calculating reference weather data from historical weather data stored in a database or retrieved from an external data source for the defined time period and the defined geographical area by applying a stochastic time series model to the historical weather data;
a weighting module for calculating weighted forecasted weather data from the multiple sets of forecasted weather data stored in the database, wherein each set of forecasted weather data is weighted by a weighting factor having a value that increases from one-time period to the next subsequent time period;
means for calculating a forecasted weather index from the forecasted weather data, wherein the type of index is defined by a respective parameter of the financial product to be forecasted, and means for calculating a forecast value of the structured financial product based on forecasted weather data for a defined time period and a defined geographical area, wherein the forecast value is calculated by applying structural parameters of the financial product to the forecasted weather index determined from the forecasted weather data;
a reference module for calculating a reference weather index from the from the reference weather data, wherein the type of index is defined by a respective parameter of the financial product to be forecasted, and calculating a reference value of the structured financial product based on the reference weather data, wherein the reference value is calculated by applying the structural parameters of the financial product to the reference weather index determined from the reference weather data;
means for calculating a ranked probability score for the reference weather data by integrating a cumulative distribution function of the forecasted weather data representing the actual relevant weather situation, and means calculating a ranked probability score for the forecasted weather data, by integrating a cumulative distribution function of the forecasted weather data representing the actual relevant weather situation,
a quality indicator module for calculating a quality indicator, indicative of a forecasting quality associated with the forecasted weather data, based on the forecasted weather data and the reference weather data, wherein the quality indicator is calculated as a ranked probability skill score from the ranked probability score for the forecasted weather data and the ranked probability score for the reference weather data, the ranked probability skill score indicating the accuracy of the forecast of the weather data compared to the reference weather data according to the percentage of improvement in accuracy of the forecast weather data over the reference weather data; and
a value forecasting module for calculating the value of the financial product from the reference value and from the forecast value weighted by the quality indicator, wherein the influence of the forecasted value on the calculated value of the financial product is adjusted, and wherein the predicted value is a put option value, V_{forecasted-put}, that is specified by:
V_{forecasted-put}=E[min(max((Pₛₜᵣᵢₖₑ−I_{forecasted})·P_{tick},0),Pₗᵢₘᵢₜ)], in which
Pₛₜᵣᵢₖₑ is a strike price value of the weather-based structured financial product,
P_{tick} is a tick price value of the weather-based structured financial product,
Pₗᵢₘᵢₜ is a limit price value of the weather-based structured financial product, and
I_{forecasted} represents a random variable which follows a distribution of a forecasted weather index.

11. The computer system according to claim 10, wherein the forecasted weather data, the reference weather data, and the historical weather data include temperature data; and wherein the forecasted weather index and the reference weather index include one of average temperature, cumulative temperature, number of heating degree days, and number of cooling degree days for the defined time period and the defined geographical area.

12. The computer system according to claim 10, wherein the quality indicator module is configured to calculate a ranked probability score for the forecasted weather data, to calculate a ranked probability score for the reference weather data, and to calculate the quality indicator as a ranked probability skill score from the ranked probability score for the forecasted weather data and the ranked probability score for the reference weather data.

13. The computer system according to claim 10, wherein the system includes a weather forecast module for calculating the forecasted weather data from multi-year historical weather data and from long-term weather forecast data covering one or more months.

14. The computer system according to claim 13, wherein the weather forecast module is configured to determine for the defined time period a first cumulated distribution function for the historical weather data, to calculate cumulative values included in terciles of the first cumulated distribution function, and to determine for the defined time period a second cumulated distribution function for the forecasted weather data, by downscaling the first cumulated distribution function using quantile levels, obtained from the long term weather forecast data, for the cumulative values included in the terciles of the first cumulated distribution function.

15. The computer system according to claim 13, wherein the weather forecast module is configured to determine for the defined time period a reference climatology comprising deterministic components from the historical weather data, and to calculate the forecasted weather data from the reference climatology and from ensemble forecasts for the defined time period.

16. The computer system according to claim 10, wherein the system includes a database with multiple sets of forecasted weather data for subsequent time periods, each set stored assigned to its respective time period; and wherein the system includes a weather forecast module for calculating the forecasted weather data from the multiple sets of forecasted weather data, each set of forecasted weather data being weighted by a weighting factor having a value increasing from one time period to a subsequent time period.

17. The computer system according to claim 10, wherein the forecasted weather data includes a first cumulative distribution function of temperature data determined from multi-year historical temperature data and from long term temperature forecast data covering one or more months; wherein the system includes a weather reference module for calculating the reference weather data, the weather reference module being configured to determine a second cumulative distribution function of temperature data by applying a stochastic time series model to the historical temperature data; wherein the value forecasting module is configured to calculate the forecast value by applying structural parameters of the financial product to a forecasted weather index determined from the first cumulative distribution function; wherein the reference module is configured to calculate the reference value by applying structural parameters of the financial product to a reference weather index, determined from the second cumulative distribution function; wherein the quality indicator module is configured to calculate a first ranked probability score based on the first cumulative distribution function, to calculate a second ranked probability score based on the second cumulative distribution function, and to calculate the quality indicator as a ranked probability skill score from the first ranked probability score and the second ranked probability score; and wherein the value forecasting module is configured to calculate the value of the financial product from the reference value and from the forecast value weighted by the quality indicator.
